(19) United States
(12) Patent Application Publication
(10) Pub. No.: US 2014/0011087 A1
(43) Pub. Date: Jan. 9, 2014

(54) ACTIVE MATERIAL SHEET AND ELECTRODE USING THE SAME

(71) Applicant: DAIDO METAL COMPANY LTD., Nagoya-shi (JP)

(72) Inventors: Kouki OZAKI, Inuyama-shi (JP); Katsumi KANEMATSU, Inuyama-shi (JP); Shinji OCHI, Inuyama-shi (JP)

(21) Appl. No.: 13/937,838

(22) Filed: Jul. 9, 2013

(30) Foreign Application Priority Data
Jul. 9, 2012 (JP) 2012-153525

(51) Int. Cl. H01G 11/28; H01M 4/70; H01M 4/36

(52) U.S. Cl. CPC H01G 11/28; H01M 4/364; H01M 4/70
USPC 429/211; 429/209; 361/502

(57) ABSTRACT

An active material sheet includes an active material that stores charge, and a binder that binds the active material. The active material is granular and 90% or more of active material particles have a particle diameter equal to or less than 20 μm. The active material particles include a first group of particles having a particle diameter equal to or less than 5 μm and a circularity ranging from 0.850 to 1.000 and a second group of particles having a particle diameter greater than 5 μm and equal to or less than 20 μm and a circularity ranging from 0.500 to 0.850.

### CROSS-REFERENCE TO RELATED APPLICATION(S)

This application is based upon and claims the benefit of priority from Japanese Patent Application No. 2012-153525 filed on, Jul. 9, 2012 the entire contents of which are incorporated herein by reference.

### FIELD

Embodiments disclosed herein relate to an active material sheet and an electrode using the active material sheet.

### BACKGROUND

Electric double layer capacitors and lithium ion batteries come in different forms such as a coin type, a wound type, and stacked type as disclosed for instance in JP 2003-243264 A, JP 2005-093859 A, and JP 2008-091099 A. Electrodes used in such applications are facing demands for improved performance.

One of such improvements being sought is improvement in energy density, in other words, increase in the electric capacitance of an electrode which in turn increases the capacitance of the capacitor or the battery in which the electrode is being used.

It has been found that the active material being used as a component of an electrode significantly affects the capacitance of the electrode. For instance, in JP 2003-347172 A, electric capacitance of the electrode using an active material is increased through control of the particle diameter of the active material.

However, the particles of the active material are not necessarily shaped regularly or uniformly. Thus, merely controlling the particle diameter of the active material as disclosed in JP 2003-347172 A may not achieve sufficient improvement in the density of active material particles of the electrode. For instance, the amount of increase in electric capacitance may be limited in JP 2003-347172 A since unnecessary spaces which do not contribute to electric capacitance reside between the active material particles of the electrode.

### SUMMARY

It is thus, one object of the present invention to provide an active material sheet with improved electric capacitance through improvement in the density of active material particles and an electrode using such active material sheet.

Diligent research by the inventors of the present application has found that circularity of the granular active material particles needs to be controlled in addition to controlling the particle diameter of the granular active material particles in order to increase the density of the active material particles of the active material sheet.

In one embodiment, the active material sheet comprises an active material that stores charge, and a binder that binds the active material. The active material is granular and 90% or more of the particles have a particle diameter d of d≦20 μm. Further, the active material includes a first group of particles and a second group of particles. The first group of particles have a particle diameter d of d≦5 μm and a circularity ranging from 0.850 to 1.000. The second group of particles have a particle diameter d ranging from 5 μm<d≦20 μm and a circularity ranging from 0.500 to 0.850.

As described above, most of the active material particles contained in the active material sheet are controlled to have a particle diameter d of d≦20 μm. Additionally, the active material particles are categorized into a first group having a relatively small particle diameter d and high circularity and a second group having a relatively large particle diameter d and low circularity. Circularity is evaluated based on the shape of the active material particles within the observation field. In one embodiment, circularity is evaluated based on the projected shape of the active material particles. The shape of the active material particles, when observed 2 dimensionally, approximates a true circle having circularity of 1.000 as circularity becomes higher.

Circularity is an index for evaluating how much an object resembles a circle and is given by the equation:

Circularity=Circumference of a circle having equivalent projected area/Perimeter of particle

According to the above equation, circularities of regular polygons can be obtained as follows.

| | |
|---|---|
| Regular Triangle | 0.7776 |
| Square | 0.8862 |
| Regular Hexagon | 0.9523 |
| Regular Octadecagon | 0.9949 |

Generally, circularity of an object tends to decrease with increase in aspect ratio.

In one embodiment of an active material sheet, a first group of active material particles having a relatively small particle diameter and high circularity fills the spaces created between a second group of active material particles having a relatively large particle diameter and low circularity. The first group of active material particles, having a relatively small particle diameter and a high circularity ranging from 0.850 to 1.000, are densely filled in the spaces between the second group of active material particles. As a result, the active material particles, as a whole, are densely filled. Increased density, in other words, the degree of fill of the active material particles in the active material sheet achieves increased electric capacitance.

In one embodiment, S1:S2=0.9 to 3.4:1.0, when total sum of area of the first group active material particles is indicated by S1 and total sum of area of the second group active material particles is indicated by S2. Controlling the area ratio of the first group active material particles to the second group active material particles in the above described range increases the electric capacitance of the active material particles as a whole.

In one embodiment, the active material sheet has a collector sheet, made of a conductor, bonded on at least one of its sides through a bonding layer to thereby form an electrode. The electrode thus obtained exhibits improved electric capacitance.

The active material sheet constituting the electrode may be replaced by a layer containing the components of the active material sheet which is provided so as to be in contact with the collector sheet made of a conductor.

Thus, such electrode, when employed in capacitors and lithium ion batteries, exhibits improved electric capacitance, in other words, static electric capacitance which improves the performance of the capacitor and lithium ion batteries.

### BRIEF DESCRIPTION OF THE DRAWINGS

FIG. 1 is a schematic cross sectional view of an electrode employing one embodiment of an active material sheet.

FIG. 2 schematically illustrates an observation field of one embodiment of the active material sheet.

FIGS. 3A and 3B taken together provide a chart summarizing the test results of embodiment EXAMPLES and COMPARATIVE EXAMPLES.

FIG. 4 is a schematic cross sectional view of an electrode according to an alternative embodiment.

### DESCRIPTION

Embodiments of an active material sheet will be described hereinafter with reference to the accompanying drawings.

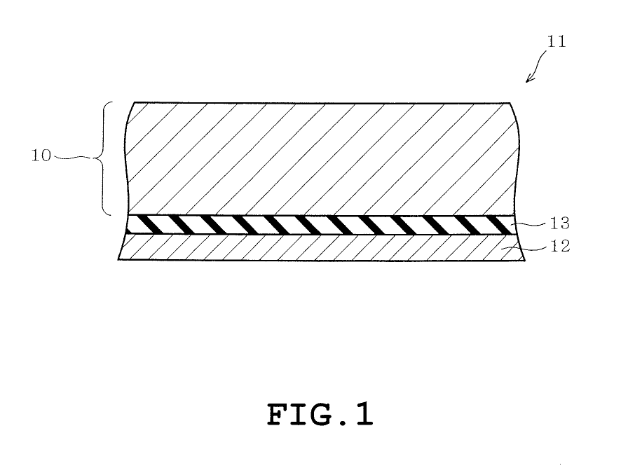

FIG. 1 illustrates active material sheet 10 employed in an electrode for capacitors and rechargeable batteries such as an electric double layer capacitor also known as EDLC, a lithium ion capacitor, and lithium ion battery. Electrode 11 employing active material sheet 10 comprises active material sheet 10, collector sheet 12, and bonding layer 13. Collector sheet 12 is made of a thin film of an electrically conductive metal such as aluminum, copper, or silver; or a thin film of an electrically conductive alloy. Collector sheet 12 is provided at least on one side of active material sheet 10. Bonding layer 13 is provided between active material sheet 10 and collector sheet 12 for bonding active material sheet 10 with collector sheet 12. Bonding layer 13 comprises an electrically conductive adhesive and thus, ensures charge transport from active material sheet 10 to collector sheet 12.

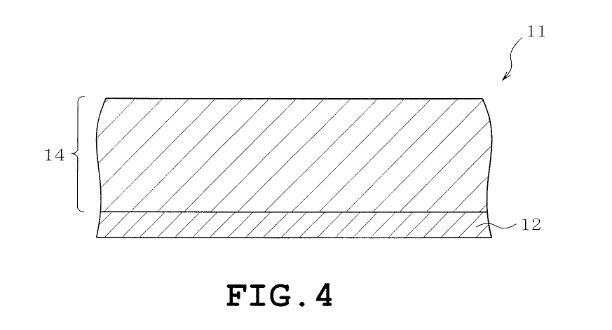

In one embodiment, active material sheet 10 was prepared by molding a kneaded mixture of active material particles 20 and binder 23 into a sheet form. In an alternative embodiment, bonding layer 13 may be eliminated, in which case, the electrode may be configured by providing layer 14 containing the components of the active material sheet by coating the surface of collector sheet 12 with semi-liquid ingredients containing the components of the active material sheet as shown in FIG. 4.

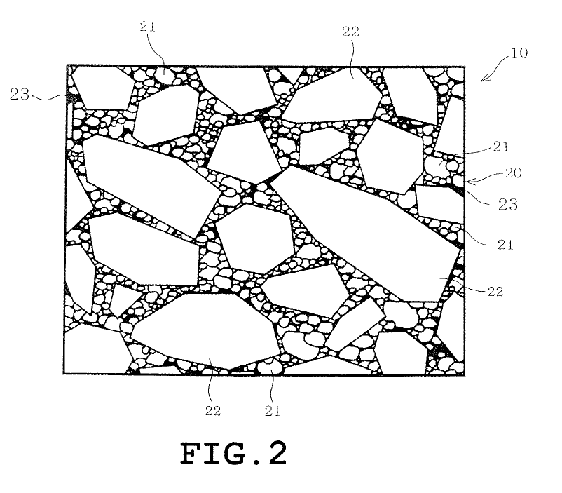

Active material sheet 10 is provided with active material particles 20 shown in FIG. 2 and binder 23. Active material particles 20 comprise a substance having charge storage capacity such as activated carbon. Apart from activated carbon, active material particles 20 may alternatively comprise other substances having charge storage capacity such as a lithium compound. Examples of preferred lithium compounds include LiCoO₂, LiMnPO₄, and LiFePO₄. Active material particles 20 include a first group of active material particles 21 and a second group of active material particles 22 that are grouped by property. Binder 23 binds active material particles 20 that constitute active material sheet 10 so as not to unbind from one another. Binder 23 comprises materials such as fluorine resin and olefin resin.

In one embodiment, 90% or more of active material particles 20 contained in active material sheet 10 observed or visible within the observation field has particle diameter d of d≦20 μm. By definition, “90% or more” is measured based on area percentage. In this case, the area of active material particles in which d≦20 μm occupies 90% or more of the total area of the active material particles observed in the observation field. By definition, observation field is a scope of field visible in an ordinary microscope. In one embodiment, the observation field is placed on a given cross section obtained by cutting active material sheet 10 along a given plane and is configured to 200 μm×200 μm. The particle diameter of active material particles which can be observed or is visible within the observation field is, for example, 0.5 μm or greater. In FIG. 2, only some of first group of active material particles 21 and some of second group of active material particles 22 are identified by reference symbols for simplicity. In FIG. 2, first group of active material particles 21 represent active material particles which are relatively small and which have a projected surface approximating a circle, whereas second group of active material particles 22 represent active material particles which are relatively large and having an angular projected surface.

First group of active material particles 21 are particles having particle diameter d falling within the range of d≦5 μm and circularity falling within the range of 0.850 to 1.000 within the observation field. Circularity is evaluated within the observation field based on the projected shape of active material particles 20. The shape of active material particles 20 become increasingly polygonal as circularity increases and approximates a true circle. Second group of active material particles 22 have a particle diameter d ranging from 5 μm<d≦20 μm and a circularity ranging from 0.500 to 0.850 within the observation field. In one embodiment, the particle diameter of active material particles 20 is obtained by the measurement of the maximum length within a projected surface of a particle which is calculated by VK-H1XA image analysis application software made by Keyence Corporation.

Assuming that the total sum of the area of first group of active material particles 21 observed in the above observation field is represented as S1, and the total sum of the area of second group of active material particles 22 observed in the above observation field is represented as S2, the ratio of area S1 to area S2 is preferably S1:S2=0.9 to 3.4:1.0.

Next, EXAMPLES of active material sheet 10 configured in the above described manner will be discussed in detail.

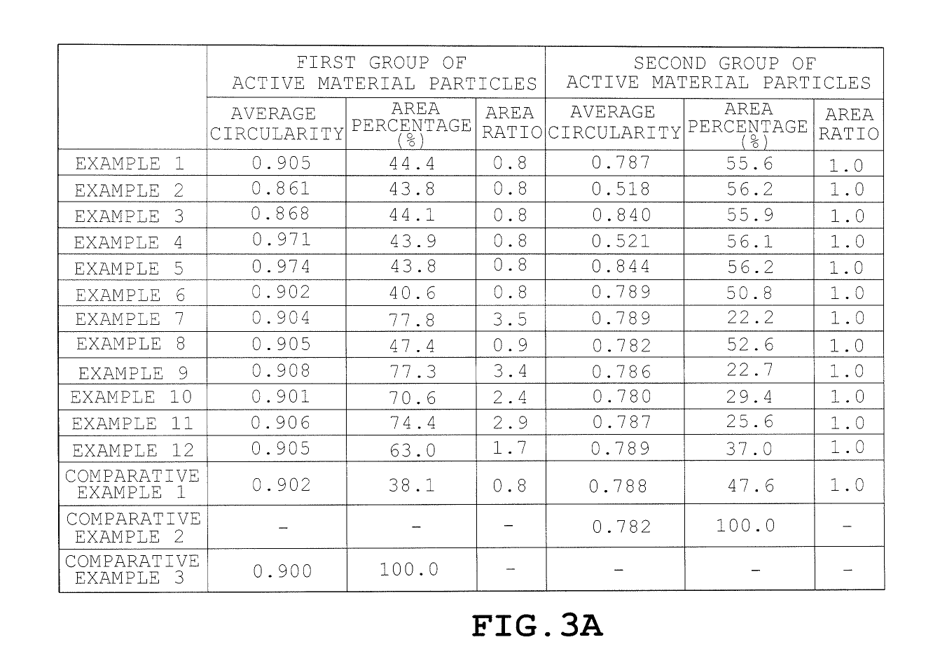

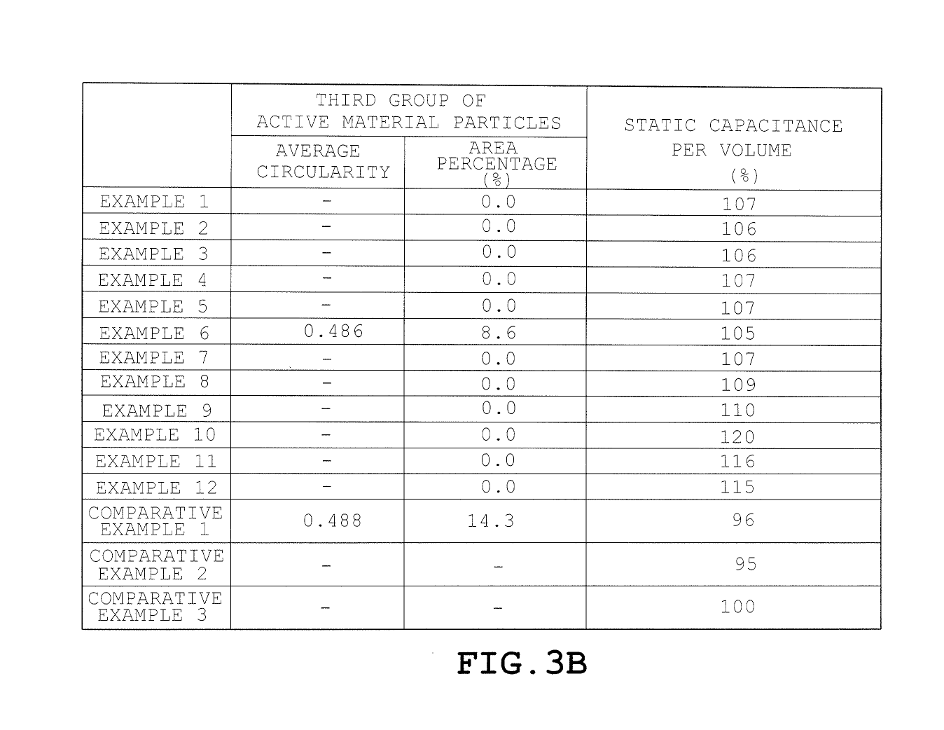

FIGS. 3A and 3B indicate the measured features of EXAMPLES 1 to 12 and COMPARATIVE EXAMPLES 1 to 3 of active material sheets. Samples of active material sheets used in EXAMPLES 1 to 12 and COMPARATIVE EXAMPLES 1 to 3 were prepared by the following processes. In preparing active material sheet 10 for EXAMPLES 1 to 12, each group of active material particles comprising activated carbon were controlled for their circularity and were kneaded after they were mixed with a binder. The circularity of the active material particles not shown to be mixed with the binder was controlled by applying mechanical force using instruments such as a ball mill, a jet mill, or a planet ball mill. The particle diameter and circularity of the active material particles were measured with dynamic image analysis methods. The kneaded mixture was rolled into a sheet being 300 μm thick. The circularity of each group of active material particles 20 of the active material sheet indicated in FIGS. 3A and 3B is given as average values within the observation field.

Active material sheets of COMPARATIVE EXAMPLES 1 to 3, on the other hand, include one or more of the first, the second, and the third group of active material particles. The third group of active material particles is a group of active material particles that is different from and does not fall in the category of either of first and second group. The circularity of the third group of active material particles is controlled to less than 0.500 at any particle diameter. The contribution of the third group of active material particles is mostly attributable to the active material particles having a particle diameter greater than 20 μm. As shown in FIGS. 3A and 3B, COMPARATIVE EXAMPLE 1 contains the first, the second, and the third group of active material particles; COMPARATIVE EXAMPLE 2 only contains the second group of active material particles and does not contain the first and the third group of active material particles; and COMPARATIVE EXAMPLE 3 only contains the first group of active material particles and does not contain the second and the third group of active material particles. The active material sheet of COMPARATIVE EXAMPLES 1 to 3 were also prepared by kneading a mixture of certain active material particle and binder, as was the case in the above described EXAMPLES 1 to 12, and thereafter rolled into a sheet being 300 μm thick.

The amount of static capacitance per volume for the above described EXAMPLES 1 to 12 was verified through comparison with COMPARATIVE EXAMPLES 1 to 3.

In FIGS. 3A and 3B, the amount of static capacitance per volume given for each of EXAMPLES 1 to 12 is a relative scale with respect to the amount of static capacitance of COMPARATIVE EXAMPLE 3 represented as “100”. As one may readily appreciate, COMPARATIVE EXAMPLE 3 is not an embodiment of the present invention. As can be gathered from FIGS. 3A and 3B, EXAMPLES 1 to 12 each show improvement in the amount of static capacitance per volume as compared to COMPARATIVE EXAMPLES 1 to 3. Comparison of EXAMPLES 1, 6, and COMPARATIVE EXAMPLE 3 having approximating circularities clearly shows that the amount of static capacitance is affected by the area that active material particles having a particle diameter of 20 μm or less occupies within the observation field. Further, comparison of EXAMPLES 2 and 3, and of EXAMPLES 4 and 5 shows that the difference of circularity of first group of active material particles 21 has a greater effect on the amount of static capacitance as compared to the difference of circularity of second group of active material particles 22. Thus, it can be understood that the amount of static capacitance can be improved by optimizing the combination of circularity of first group of active material particles 21 and circularity of second group of active material particles 22.

This may be explained by the following.

First group of active material particles 21 has a relatively higher circularity and a relatively smaller particle diameter as compared to second group of active material particles 22. Thus, second group of active material particles 22 having a relatively lower circularity and a relatively larger particle diameter creates many spaces between one another as can be seen in FIG. 2. In contrast, first group of active material particles 21 having higher circularity and smaller particle diameter is filled efficiently into the spaces created by second group of active material particles 22. As a result, abundance ratio of active material particles 20 within active material sheet 10, in other words, the degree of agglomeration of active material particles 20 is increased. First group of active material particles 21 having high circularity densely fills the spaces created by second group of active material particles 22 even if the shapes of the created spaces are irregular. As described above, the amount of static capacitance of active material sheet 10 can be improved by controlling the circularity of both first group of active material particles 21 and second group of active material particles 22.

Conventionally, active material sheets were prepared by adding a conduction assistant comprising carbon particles such as carbon black or Ketjen black into the spaces created between the active material particles. The embodiments described above allow formation of active material sheet without a conduction assistant and achieve increased electric capacitance by increasing the density of the active material particles in the active material sheet. In an alternative embodiment, a conduction assistant may be added to the active material sheet as long as sufficient amount of static capacitance can be secured through appropriate control of first group of active material particles 21 and second group of active material particles 22.

As described above, increase in the amount of static capacitance of active material sheet was achieved by optimally mixing first group of active material particles 21 and second group of active material particles 22.

Next, the influence of area ratio of first group of active material particles 21 and second group of active material particles 22 on the amount of static capacitance per volume will be verified.

EXAMPLES 7 to 12 are modified variants of EXAMPLE 1 in that the area of first group of active material particles 21 and the area of second group of active material particles 22 have been controlled differently from those of EXAMPLE 1. In other words, average circularity of first group of active material particles 21 and average circularity of second group of active material particles 22 are substantially the same as those of EXAMPLE 1. Active material sheets 10 of EXAMPLES 7 to 12 were prepared by processes similar to those of EXAMPLE 1 with the exception of difference in mixture ratio of first group of active material particles 21 and second group of active material particles 22. The area ratio of first group of active material particles 21 and second group of active material particles 22 of EXAMPLES 7 to 12 was controlled in the above described manner. In FIGS. 3A and 3B, area S1 representing the area of first group of active material particles 21 is given in a relative scale when area S2 of second group of active material particles 22 is represented as “1.0”.

As can be seen from the comparison of EXAMPLES 1 and 8 and of EXAMPLES 7 and 9, the area of first group of active material particles 21 preferably ranges from 0.9 to 3.4 when it is assumed that the area of second group of active material particles 22 is “1.0”. In other words, the area ratio of area S1 of first group of active material particles 21 and area S2 of second group of active material particles 22 preferably takes the range of:

### S1:S2=0.9 to 3.4:1.0

Further, according to comparison of EXAMPLES 8 and 12 and of EXAMPLES 9 and 11, the area ratio more preferably takes the range of:

### S1:S2=1.7 to 2.9:1.0

It is believed that the charge retention property of second group of active material particles 22, having relatively large particle diameter, becomes more influential when area percentage of first group of active material particles 21 is equal to or less than 3.4. Thus, the upper limit of area ratio of first group of active material particles 21 is preferably 3.4 and more preferably 2.9.

When the area ratio of first group of active material particles 21 is equal to or greater than 0.9 on the other hand, the amount of first group of active material particles 21, having a large circularity, is increased. Increase in the abundance of first group of active material particles 21 increases the amount of first group of active material particles 21 filled in the spaces created between second group of active material particles 22. As a result, it is believed that the amount of static capacitance is increased when area ratio of first group of active material particles 21 is equal to or greater than 0.9. Thus, the lower limit of area ratio of first group of active material particles 21 is preferably 0.9 and more preferably 1.7.

As described above, active material sheet 10 achieved high amount of static capacitance by optimally controlling the area ratio of first group of active material particles 21 and second group of active material particles 22.

Further, an electrode, a capacitor, and a lithium ion battery employing active material sheet 10 or layer 14 configured like EXAMPLES 1 to 12 achieved high static capacitance. When applying an electrode, comprising active material sheet 10 or layer 14 configured like EXAMPLES 1 to 12, to a capacitor or a lithium ion battery, known configurations such as coin, wound, and stacked types may be employed in implementation.

The foregoing description and drawings are merely illustrative of the principles of the present invention and are not to be construed in a limited sense. Various changes and modifications will become apparent to those of ordinary skill in the art. All such changes and modifications are seen to fall within the scope of the invention as defined by the appended claims.

What is claimed is:

1. An active material sheet comprising:
an active material that stores charge;
a binder that binds the active material;
wherein the active material is granular and 90% or more of active material particles have a particle diameter equal to or less than 20 μm, and
wherein the active material particles include a first group of particles having a particle diameter equal to or less than 5 μm and a circularity ranging from 0.850 to 1.000 and a second group of particles having a particle diameter greater than 5 μm and equal to or less than 20 μm and a circularity ranging from 0.500 to 0.850.

2. The active material sheet according to claim 1, wherein
S1:S2=0.9 to 3.4:1.0
when S1 represents a sum of areas of the first group of particles and when S2 represents a sum of areas of the second group of particles.

3. An electrode comprising the active material sheet according to claim 1, a collector sheet made of a conductive material and contacting at least one side of the active material sheet, and a bonding layer bonding the active material sheet and the collector sheet.

4. An electrode comprising the active material sheet according to claim 2, a collector sheet made of a conductive material and contacting at least one side of the active material sheet; and
a bonding layer bonding the active material sheet and the collector sheet.

5. An electrode comprising:
a collector sheet made of a conductive material; and
a layer provided over the collector sheet;
wherein the layer includes:
an active material that stores charge, and
a binder that binds the active material, wherein the active material is granular and 90% or more of active material particles have a particle diameter equal to or less than 20 μm, and
wherein the active material particles include a first group of particles having a particle diameter equal to or less than 5 μm and a circularity ranging from 0.850 to 1.000 and a second group of particles having a particle diameter greater than 5 μm and equal to or less than 20 μm and a circularity ranging from 0.500 to 0.850.

6. The electrode according to claim 5, wherein
S1:S2=0.9 to 3.4:1.0
when S1 represents a sum of areas of the first group of particles and when S2 represents a sum of areas of the second group of particles.

7. A capacitor comprising the electrode according to claim 3.

8. A capacitor comprising the electrode according to claim 4.

9. A capacitor comprising the electrode according to claim 5.

10. A capacitor comprising the electrode according to claim 6.

11. A lithium ion battery comprising the electrode according to claim 3.

12. A lithium ion battery comprising the electrode according to claim 4.

13. A lithium ion battery comprising the electrode according to claim 5.

14. A lithium ion battery comprising the electrode according to claim 6.
